(19) United States
(12) Patent Application Publication
(10) Pub. No.: US 2004/0014341 A1
(43) Pub. Date: Jan. 22, 2004

(54) Connection structure of connector pin and signal line and semiconductor package using it

(76) Inventors: Akira Katou, Itami-shi (JP); Takashi Tsuno, Itami-shi (JP); Motoyoshi Tanaka, Itami-shi (JP)

Correspondence Address: MCDERMOTT WILL & EMERY, 600 13TH STREET, N.W., WASHINGTON, DC, 20005-3096, US

(21) Appl. No.: 10/297,248

(22) PCT Filed: Jan. 17, 2002
(86) PCT No.: PCT/JP02/00299

(30) Foreign Application Priority Data
Apr. 5, 2001 (JP) 2001-107213

(51) Int. Cl. H01R 13/62

(52) U.S. Cl. 439/153

(57) ABSTRACT

The width of a signal line 3 is made narrower at a part connected with a connector pin 1 than a signal line width that can match the connector characteristic impedance. Furthermore, the width of the signal line 3 is made narrower at the part connected with the connector pin 1 than the projection width of the connector pin diameter. The disclosed connection structure of a planer waveguide signal line can, when a high frequency signal is transmitted from a rod-shaped coaxial structure to the signal line, prevent the transmissivity deterioration caused by radiation of the signal or reflection of the signal back to the outgoing side at the part of the signal line connected with a connector pin. The connection structure can also minimize transmission loss due to assembling error made during assembling into a semiconductor package.

### TECHNICAL FIELD

This invention relates to a structure of a semiconductor package for a high frequency device, and particularly to a connection structure of a circuit board provided with a signal line of a planer waveguide and a connector pin.

### BACKGROUND ART

Recently, a semiconductor package for high frequency having a signal line circuit that efficiently transmits a high frequency signal exceeding several GHz is demanded, to comply with increased working speed of a semiconductor element and high frequency to raise signal density.

As for such a semiconductor package for high frequency, it is necessary to restrain the reflection and loss of the signal at a junction when the high frequency signal transmitted through a coaxial line is transmitted to the various semiconductor devices through the connector pin, the junction, and the signal line of the planer waveguide. The effect of such restraining is especially remarkable as the signal becomes high frequency. Though there are various forms of the planer waveguide, the present invention is applicable to both a microstrip line and a coplanar line.

An example of a structure in which a connector pin and a signal line are connected with high accuracy is proposed in Japanese Patent Laying-Open No. 11-224757. FIG. 15 is a fragmentary sectional view of the connection structure of a connector pin 103 and a signal line 106 in a semiconductor package 100. In FIG. 15, 101 is a part of the package frame. A glass bead 102 connected to the termination of the coaxial line proceeds in the arrow X direction and is guided in a blind hole 104 set up in the package frame 101. On the other hand, a recessed groove 107 into which connector pin 103 is inserted is formed at the junction of an end of the signal line 106 formed on a dielectric substrate 105.

When the connector pin 103 and the signal line 106 are connected, both are made to fit so that a recessed groove 107 may hold the tip of the connector pin 103, and they are finally connected by a solder 108. It is explained that the connector pin 103 and the recessed groove 107 are positioned properly by such a structure, and the positioning accuracy of the connector pin 103 and the signal line 106 improves automatically. But if the position of the end of the connector pin 103 and the position of the recessed groove 107 formed on the dielectric substrate 105 are not accurate, they cannot be connected physically.

### DISCLOSURE OF THE INVENTION

The connection structure proposed in Japanese Patent Laying-Open No. 11-224757 lacks sufficiency to minimize a transmission loss in the high frequency area of the signal, especially when the frequency of the signal becomes high and a connector pin diameter becomes small. In other words, when the connector pin diameter becomes small, positioning of the recessed groove and the connector pin becomes difficult. In addition, there is the concern for the occurrence of transmission loss to the signal line, which is a planer waveguide, due to a change in the position of the top and bottom of the signal line and the connector pin, and the occurrence of transmission loss due to discontinuity of circuit width caused by a variation in the coating amount of the solder filled in the recessed groove.

An object of the present invention is to minimize the above-described factors that cause the transmission loss of the signal at the high frequency area and to restrain radiation and reflection.

The connection structure of a signal line and a connector pin in a semiconductor package according to an embodiment of the present invention is such that the width of the signal line connected to the connector pin is made narrower than the width of a signal line which can match the connector characteristic impedance.

The junction with the above connection structure is a junction for leading an electrical signal transmitted through a coaxial line to a thin film signal line, which is a planer waveguide formed on a dielectric substrate, from the tip of a connector pin piercing through an insulating glass bead.

Also, the junction part is a junction that transmits an electrical signal, which is converted from an optical signal transmitted through an optical fiber by an optical semiconductor device, to a coaxial line.

The width of the signal line is made narrower at the junction part that is connected with the connector pin than the projection width of a connector pin diameter.

The width of the signal line is increased gradually from the narrow width of the junction part connected with the connector pin to the wide width of a non-junction part of the signal line.

### BRIEF DESCRIPTION OF DRAWINGS

In the drawings:

FIG. 1 is a schematic perspective view of a semiconductor package which has a connection structure of a connector pin and a signal line of the present invention.

FIG. 2 is a plan view of a signal line of the present invention.

FIG. 3 is a projection view of a junction of Comparative Example 1.

FIG. 4 is a projection view of a junction of Example 1.

FIG. 5 is a result of simulation in which reflection characteristics of Comparative Example 1 and Example 1 are compared.

FIG. 6 is a result of simulation in which transmission characteristics of Comparative Example 1 and Example 1 are compared.

FIG. 7 is a projection view of the junction of Comparative Example 2.

FIG. 8 is a result of simulation in which the reflection characteristics of Comparative Example 1 and Comparative Example 2 are compared.

FIG. 9 is a result of simulation in which the transmission characteristics of Comparative Example 1 and Comparative Example 2 are compared.

FIG. 10 is a projection view of the junction of Example 2.

FIG. 11 is a result of simulation in which reflection characteristics of Example 1 and Example 2 are compared.

FIG. 12 is a result of simulation in which the transmission characteristics of Example 1 and Example 2 are compared.

FIG. 13 is a result of simulation in which reflection characteristics of Comparative Example 1 and 3, and Example 3 and 4 are compared.

FIG. 14 is a result of simulation in which transmission characteristics of Comparative Example 1 and 3 and Example 3 and 4 are compared.

FIG. 15 is a partial sectional view of a junction of prior art.

### BEST MODE FOR CARRYING OUT THE INVENTION

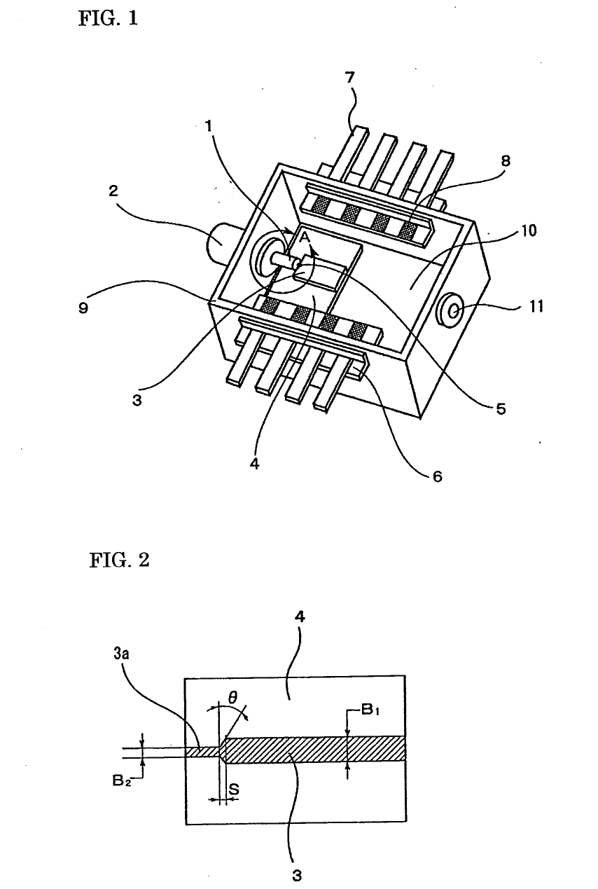

Examples embodying the present invention are explained in detail with reference to drawings as follows. FIG. 1 shows a schematic perspective view of a semiconductor package which has a connection structure of a connector pin and a signal line of the present invention.

A high frequency signal transmitted through a coaxial line (not illustrated in the figure) is transmitted to a connector pin 1 which pierces through the inside of an insulating glass bead 2. The periphery of the glass bead 2 is pushed into a hole of a package frame 9 consisting of Cu—W alloys or Fe—Ni alloys and it is fixed. A loading base 10 made of the same metal as the package frame 9 is bonded to a bottom part of the semiconductor package with the brazing filler metal. A thin film signal line 3 is formed, by vacuum evaporation or plating of low resistance metal such as gold, on a dielectric substrate 4 which consists of aluminum nitride and so on. The connector pin 1 and the signal line are connected together with solder 5.

A ceramic feed through 6, which is attached to an upper part of each side of the package frame 9, is provided with lead frame 7 that are connected with metallized lines 8. An insulating substrate of high heat radiation (not illustrated in the figure) is installed inside the semiconductor package. An optical semiconductor device such as a laser diode for changing an electrical signal to an optical signal or a photo diode for changing an optical signal to an electrical signal, a Peltier element that is an electronic cooling element, a capacitor, a resistance, and so on are mounted on package. These elements are connected with the signal line 3 or the metallized lines 8 by wire bonding and so on, and these elements are driven by the electric power supplied from the lead frame 7, and they are made to work as a semiconductor module. A window 11 is used for input and output of the optical signal between an optical fiber and the module.

FIG. 2 is an enlarged plan view of the signal line 3 around the part A in FIG. 1. The signal line 3 made of the thin film deposited on the dielectric substrate 4 by vacuum evaporation has a width of B₁ at the non-junction part, and the width B₂ at a junction part 3a connected with the connector pin 1 is set smaller than the non-junction part. It is desirable that the width B₂ of the junction part 3a is 0.4˜0.7, assuming the width B₁ of the non-junction part of the signal line 3 to be 1.

Also, preferably, the width is increased gradually from the width B₂ to the width B₁. In order to prevent transmission loss due to the abrupt change in the width of the signal line 3, it is desirable that the change from the width B₂ to the width B₁ is at an optional angle θ inclining toward the non-junction part such that the following relation (1) is satisfied, where θ is an inclination angle and S is the width of a transition part.

tan θ=2S/(B₁−B₂) (1)

Thus, making the width change from the width B₂ to the width B₁ gradual, and not orthogonal, is effective for reducing the signal reflection.

### EXAMPLES

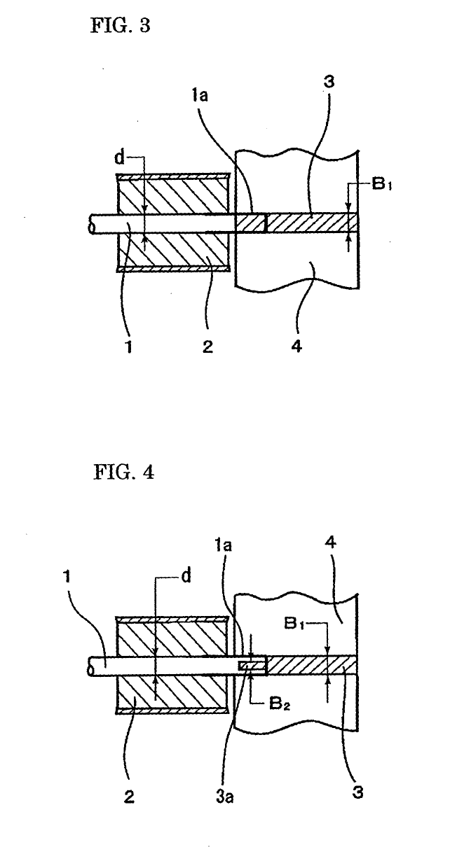

In the following, the effects obtained by the features of the present invention are described. FIG. 3 illustrates an outline 1a of a connector pin 1 as projected on a signal line 3 in a plan view of the part A of FIG. 1. The actual size of the width B₁ of the signal line 3 in Comparative Example 1 is formed in the uniform size of 0.23 mm as illustrated, and the relative dielectric constant of the circuit board is 9.0. A pin diameter d of the connector pin 1 penetrating through a glass bead 2 is 0.23 mm, and the relative dielectric constant of the glass is 4.4. The connector pin 1 and the signal line 3 were connected with a predetermined quantity of solder.

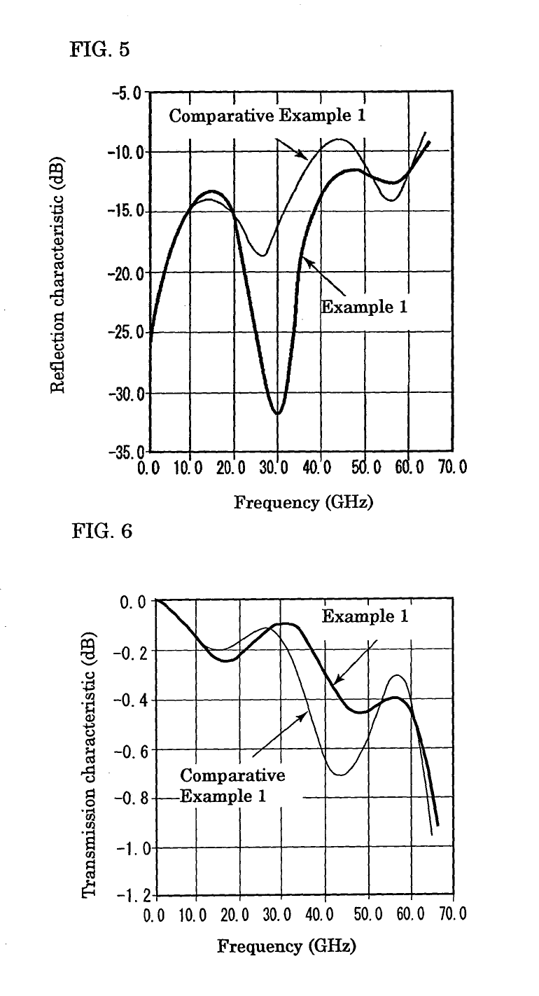

FIG. 4 illustrates an outline la of a connector pin 1 as projected on a signal line 3 in a plan view of the part A of FIG. 1. The actual size of the width B₁ of the signal line 3 on a dielectric substrate is 0.23 mm, and the width B₂ of the signal line 3a in a junction part is 0.12 mm, as illustrated, in Example 1. The change of the width from the signal line 3a of the junction part to the signal line 3 of the non-junction part was made through a right angle corner. The pin diameter d of a connector pin 1 penetrating through a glass bead 2 was 0.23 mm, the same as in Comparative Example 1. The quantity of solder for connecting the connector pin 1 and the signal line 3 was set equal to that of Comparative Example 1. A simulation was carried out with the samples of Comparative Example 1 and Example 1. In the simulation, reflection characteristic and transmission characteristic from the coaxial structure on the left to the planer waveguide on the right shown in FIG. 3 or FIG. 4 were computed with the finite element method (FEM). The calculation results are shown in FIG. 5 and FIG. 6.

FIG. 5 is a semilogarithm graph showing the frequency dependence of the reflection and it indicates that the reflection is smaller as the minus number is smaller (that is, the absolute value is larger). In FIG. 5, the horizontal axis represents frequency and the vertical axis represents reflection characteristic, and the thin line is the simulation calculation result showing the reflection characteristic in Comparative Example 1 illustrated in FIG. 3. The thick line in FIG. 5 is a simulation calculation result of the reflection characteristic of Example 1 in FIG. 4. As can be seen from FIG. 5, the reflection characteristic of Example 1 is better than that of Comparative Example 1 remarkably in the high frequency range from the frequency exceeding about 20 GHz to the frequency slightly exceeding 50 GHz.

FIG. 6 a graph plotting an evaluation result of the transmission characteristic of the signal and shows that the signal is transmitted without loss of the signal as a plot approaches zero in the ordinate. The thin line is a simulation calculation result showing the transmission characteristic of Comparative Example in FIG. 3. And the thick line is a simulation calculation result of the transmission characteristic of Example 1 in FIG. 4. In consideration of FIG. 6, the transmission characteristic of Example 1 is better than that of Comparative Example 1 in the high frequency range from the frequency of about 30 GHz to the frequency of slightly exceeding 50 GHz.

The samples of the same specifications as those of Example 1 and Comparative Example 1 were prepared, and the results of measuring their reflection and transmission characteristics by a network analyzer are shown in Table 1 for reference to prove the reliability of the simulation calculation results.

TABLE 1

| | | Frequency (GHz) | | |
|---|---|---|---|---|
| | | 10 GHz | 30 GHz | 60 GHz |
| Reflection | Example 1 | −40 dB | −25 dB | −20 dB |
| Characteristics | Comparative Example 1 | −27 dB | −15 dB | −13 dB |
| Transmission | Example 1 | −0.8 dB | −1 dB | −2 dB |
| Characteristics | Comparative Example 1 | −0.8 dB | −1 dB | −2 dB |

The simulation calculation result and the actual values show the tendency of correspondence qualitatively though differences of absolute values exist. Moreover, characteristics of Example 1 were better than Comparative Example 1 in the wide frequency range.

Though it is desirable that the center of the connector pin 1 coincide with the center of the signal line 3, an assembling error cannot be avoided when the dielectric substrate 4 is connected with the package frame 9. FIGS. 8, 9, 11 and 12 show simulation calculation results of the influence.

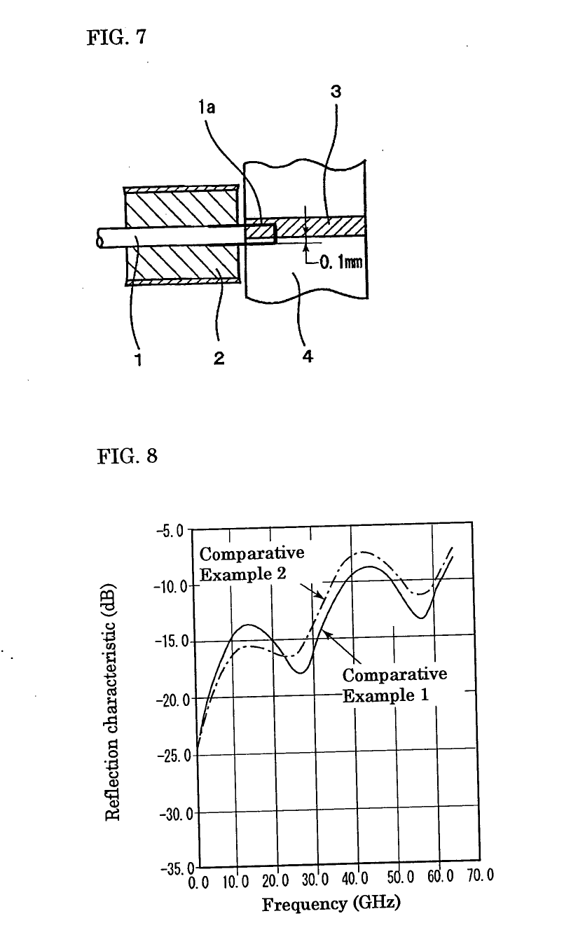

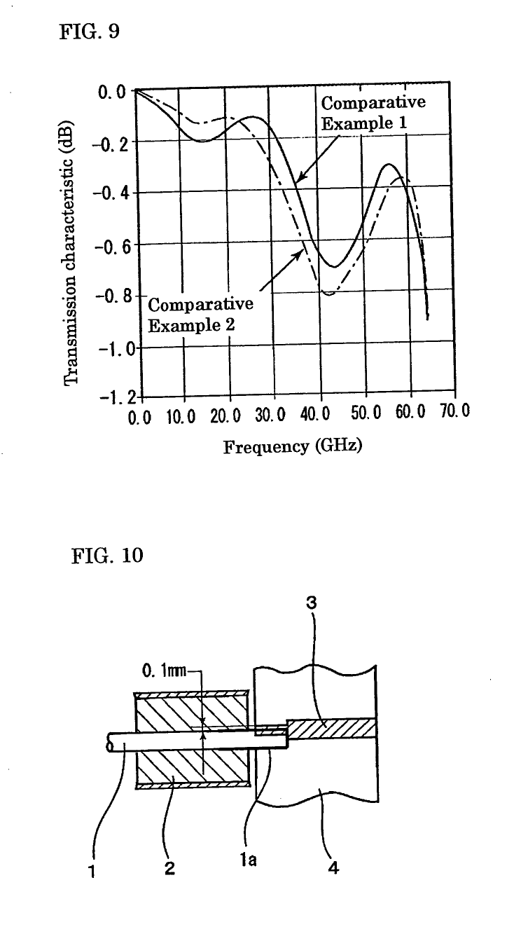

Comparative Example 1 shown in FIG. 3 and Comparative Example 2 shown in FIG. 7 are evaluated. The calculation model of a connection structure of Comparative Example 2 of FIG. 7 is basically the same as Comparative Example 1 in which the center of the connector pin 1 coincides with the center of the signal line 3, except that deviation of the border line 1a of the connector pin 1 and the outside of the signal line 3 is 0.1 mm. In FIG. 8, the broken line is the result of a simulation calculation showing the reflection characteristics of Comparative Example 2 of FIG. 7, and the solid line is the reflection characteristic of Comparative Example 1. In consideration of FIG. 8, which is the result of the simulation calculation of the reflection characteristics of Comparative Example 1 and Comparative Example 2, the reflection characteristic of Comparative Example 1 in which the center of the connector pin 1 and the center of the signal line 3 coincide is better than that of Comparative Example 2 in the high frequency range from the frequency exceeding about 20 GHz to the frequency slightly exceeding 60 GHz. FIG. 9 shows the simulation calculation results of the transmission characteristics. In FIG. 9, the broken line is the result of a simulation calculation of the transmission characteristics in Comparative Example 2 of FIG. 7, and the thin line is the transmission characteristics of Comparative Example 1. As can be seen from FIG. 9, Comparative Example 1 in which the center of the connector pin 1 and the center of the signal line 3 coincide has better transmission characteristics than Comparative Example 2 in the high frequency range from the frequency exceeding about 20 GHz to the frequency of about 60 GHz.

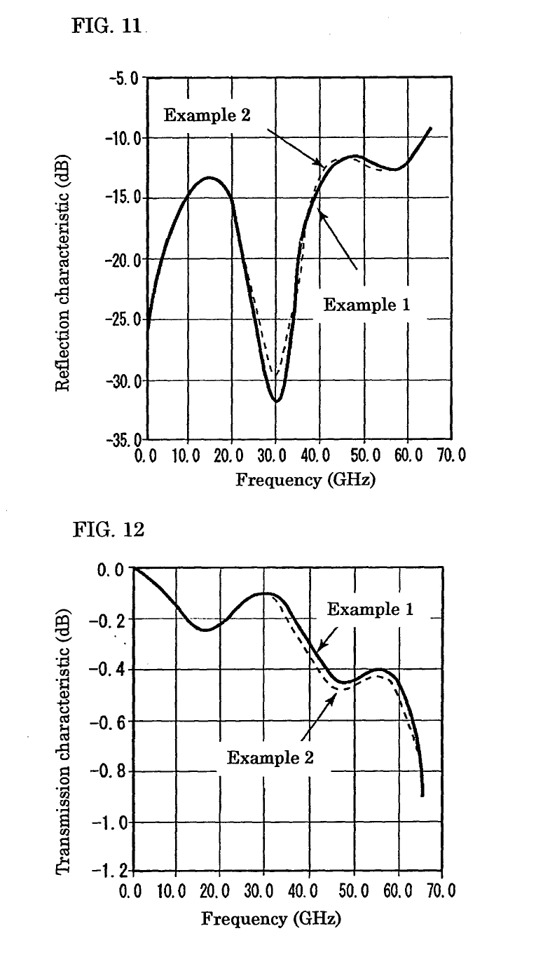

Furthermore, Example 2 that was prepared for comparison with Example 1 is shown in FIG. 10. The calculation model of a connection structure of Example 2 is basically the same as Example 1 in which the center of the connector pin 1 coincides with the center of the signal line 3, except that deviation of the border line 1a of the connector pin 1 and the outside of the signal line 3 is 0.1 mm. In FIG. 11, the dotted line is the result of a simulation calculation which shows the reflection characteristics of Example 2 of FIG. 10, and the solid line is the reflection characteristics of Example 1. In consideration of FIG. 11 which is the result of the simulation calculation of the reflection characteristics of Example 1 and Example 2, Example 1 has slightly better reflection characteristic than Example 2 at the frequency around 30 GHz.

In FIG. 12, the dotted line is a result of the simulation calculation of transmission characteristics in Example 2 of FIG. 10, and the solid line is the transmission characteristics of Example 1. In consideration of FIG. 12 which is the result of the simulation calculation of the transmission characteristics of Example 1 and Example 2, Example 1 has better transmission characteristic than Example 2 in the frequency range from about 30 GHz to 60 GHz, but the difference between Example 1 and Example 2 is slight. It is proved that the connection structure of Example 2 receives less influence of the deviation on both characteristics than Comparative Example 2 which has the same deviation as Example 2. Therefore, it is possible to conclude that Examples of the present invention are minimally affected by the assembling error.

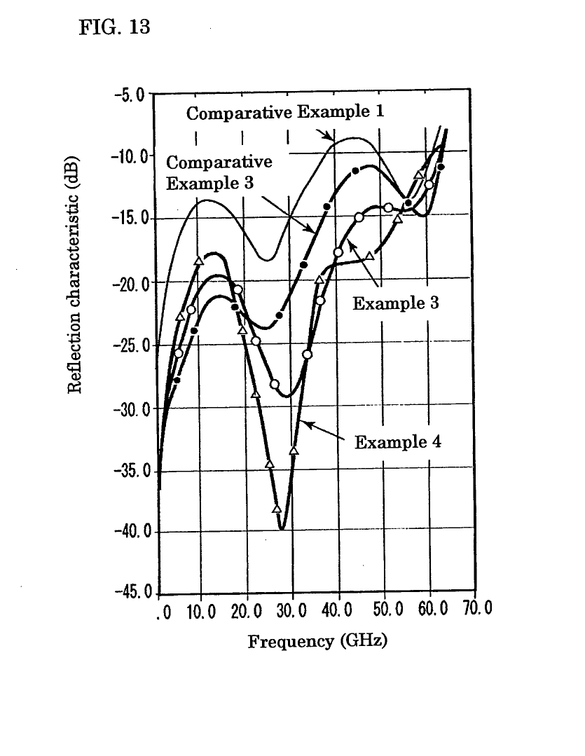

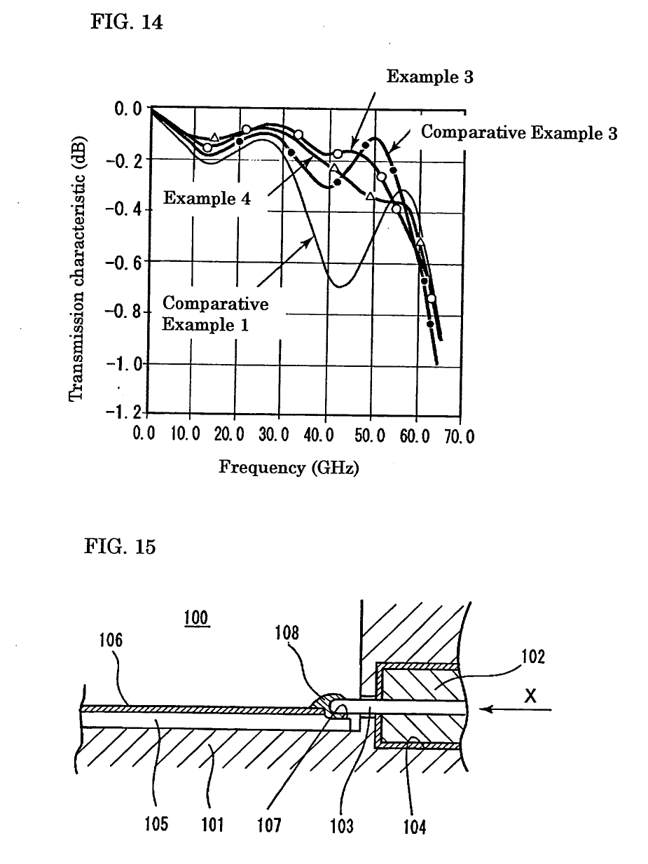

Results on the investigation on the appropriate width of the junction part 3a of the signal line 3 is explained as follows. The samples prepared had a connector pin diameter d, the width B₁ of a signal line 3 of a circuit part and other specifications that were the same as in Example 1 illustrated in FIG. 4 except that in Comparative Example 3, the width B₂ of a junction part 3a was 0.05 mm, in Example 3 the width B₂ was 0.1 mm corresponding to 0.4 of the width B₁, and in Example 4 the width B₂ was 0.16 mm corresponding to 0.7 of the width B₁. Comparative Example 1 illustrated in FIG. 3 was also prepared for comparison. A reflection characteristic and a transmission characteristic that were obtained by using the same simulation calculation as mentioned above are shown in FIG. 13 and FIG. 14, respectively.

In FIG. 13 and FIG. 14, Comparative Example 1 is shown by a thin line and Comparative Example 3 is shown by a thick line with filled circles, Example 3 is shown by a thick line with open circles and Example 4 is shown by a thick line with open triangles.

Considering the results of the simulation calculations of the reflection characteristics in FIG. 13, Examples 3 and 4 show good results in the high frequency range from the frequency exceeding about 20 GHz to 55 GHz. On the other hand, the reflection of Comparative Example 1 is large and Comparative Example 3 also shows the tendency of the large reflection.

Considering the results of the simulation calculations of the transmission characteristics in FIG. 14, Examples 3 and 4 show good results in the high frequency range from the frequency of around 10 GHz to 60 GHz. On the other hand, the transmission characteristics of Comparative Example 1 show an overall deterioration. Comparative Example 3 has a partial frequency range of a good transmission characteristic, however, it is limited to the small frequency range. It is considered that the joint structure having excellent reflection and transmission characteristics in the high frequency range of 20-55 GHz can be obtained by setting the line width ratio B₂/B₁ of the junction part of the signal line to 0.4-0.7.

Industrial Applicability

In the connection structure of a connector pin and a signal line, the radiation and the reflection of the signal in a junction part is minimized and the deterioration of the transmission loss can be prevented by a structure in which the width of a signal line connected with a connector pin is made narrower than the width of a signal line which can coincide with the connector characteristic impedance, and the width of the junction part of the signal line is made narrower than the projection width of the connector pin diameter. Moreover, the assembling error of the connector pin and the signal line is absorbed in the semiconductor package having such connection structure and the deterioration of the transmission loss of the signal can be prevented.

1. A connection structure in which a connector pin and a signal line is connected in a semiconductor package, wherein
the width of the signal line is narrower at a junction part connected with the connector pin than a signal line width that can match the connector characteristic impedance.

2. A connection structure according to claim 1,
wherein a junction leads an electrical signal transmitted through a coaxial line to the signal line of a thin film planer waveguide formed on a dielectric substrate, from the tip of the connector pin piercing through an insulating glass bead.

3. A connection structure according to claim 1,
wherein a junction transmits an electrical signal to a coaxial line, the electrical signal being an optical signal transmitted through an optical fiber and converted into the electrical signal by an optical semiconductor device.

4. A connection structure according to any one of claims 1 to 3,
wherein the width of the signal line is narrower at a junction part connected with the connector pin than the projection width of the connector pin diameter.

5. A connection structure according to any one of claims 1 to 3,
wherein the width of the signal line is increased gradually from a narrow width of the junction part connected with the connector pin to a wide width of the nonjunction part of the signal line.

6. A semiconductor package comprising a connector pin and a signal line, wherein the connector pin and the signal line have a connection structure according to any one of claims 1 to 3.
